(19) United States
(12) Patent Application Publication
(10) Pub. No.: US 2012/0013117 A1
(43) Pub. Date: Jan. 19, 2012

(54) MAGNETIC AIR HOSE CONNECTOR

(76) Inventor: Arnon Bernshtein, Doar Na Menashe (IL)

(21) Appl. No.: 12/836,633

(22) Filed: Jul. 15, 2010

(51) Int. Cl. F16L 33/00

(52) U.S. Cl. 285/9.1

(57) ABSTRACT

A magnetic air connector (200) including an air inlet (132) configured to connect to an air source (140), a magnet (220) with a hollow area to enable air flow through it, a hollow pin (212) is inserted into the hollow area of the magnet (220). In addition it includes an attach element (204) configured to attach to an air consumer (104, 108) from a one side and the magnet (220) from the other side.

### CROSS REFERENCE TO RELATED APPLICATIONS

Reference is made to commonly-assigned copending U.S. patent application Ser. No. ______ (Attorney Docket No. 96409/NAB), filed herewith, entitled METHOD FOR CONNECTING AN AIR HOSE, by Arnon Bernshtein; the disclosure of which is incorporated herein.

### FIELD OF THE INVENTION

This invention relates to a laser imaging device and more specifically to connecting an air source to the imaging device for facilitating mounting of media to the imaging device.

### BACKGROUND OF THE INVENTION

In many types of printing, particularly flexographic printing, offset printing and screen printing, there is an advantage in using seamless sleeves as printing elements instead of plates wrapped around printing cylinders. Seamless sleeves allow printing of continuous patterns. The use of seamless sleeves allows printing presses to operate in a smoother manner. Before a sleeve can be mounted on a printing press it has to be imaged and processed, although some materials are available today which do not require processing. The printing sleeves 116 are imaged on laser imaging device 100 as is shown in FIG. 1.

Such machines have a mandrel 104 on which a printing sleeve 116 is mounted directly. Alternatively several shells 108 (or mandrel adaptors) of different diameters may be provided that can be mounted on the mandrel 104 to accommodate a variety of different printing sleeves 116. A laser imaging head 120 is adapted to travel along the longitudinal axis of the printing sleeve 116 on imaging head tracks 124, controlled by lead screw 128.

Printing sleeve 116 is loaded over the mandrel adaptor 108. The printing sleeve 116 may be a thin-walled metal or composite cylindrical tube with media applied to the outer surface. The mandrel adaptor 108 may be provided with a number of air holes 112 in its surface through which air can be forced. This air flow creates an air bearing over mandrel adaptor 108 and permits printing sleeve 116 to be floated on a cushion of air onto the mandrel adapter 108, the air expanding printing sleeve 116 to enable easy loading and positioning. The air is supplied by air source 140 through air hose 136. Air hose 136 is fixed to air supply 140 on one side and to air inlet 132 on mandrel adapter 108 (or to mandrel 104), on the other side of the air hose 136. When the supply of forced air is discontinued, printing sleeve 116 contracts to form an tight fit with mandrel adaptor 108.

Replaceable mandrels or mandrel adaptors can be used. Air pressure is automatically connected to the inside of the mandrel to slide sleeves on and off. As the whole operation can be pneumatically or hydraulically activated, the machine operator only needs to slide the sleeves on and off.

Fixing air hose 136 to air inlet 132 on mandrel adaptor 108 and disconnecting the air hose 136 from inlet 132, requires some effort and may cause problems during normal operation of imaging device 100. A solution to prevent such problems is necessary.

### SUMMARY OF THE INVENTION

Briefly, according to one aspect of the present invention, a magnetic air connector includes an air inlet configured to connect to an air source, a magnet with a hollow area to enable air flow through it, and a hollow pin inserted into the hollow area of the magnet. In addition it includes an attach element configured to attach to an air consumer from a one side and the magnet from the other side.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

FIG. 1 is a schematic showing a prior art laser processing system with a sleeve mounted on a mandrel adaptor using air supply;

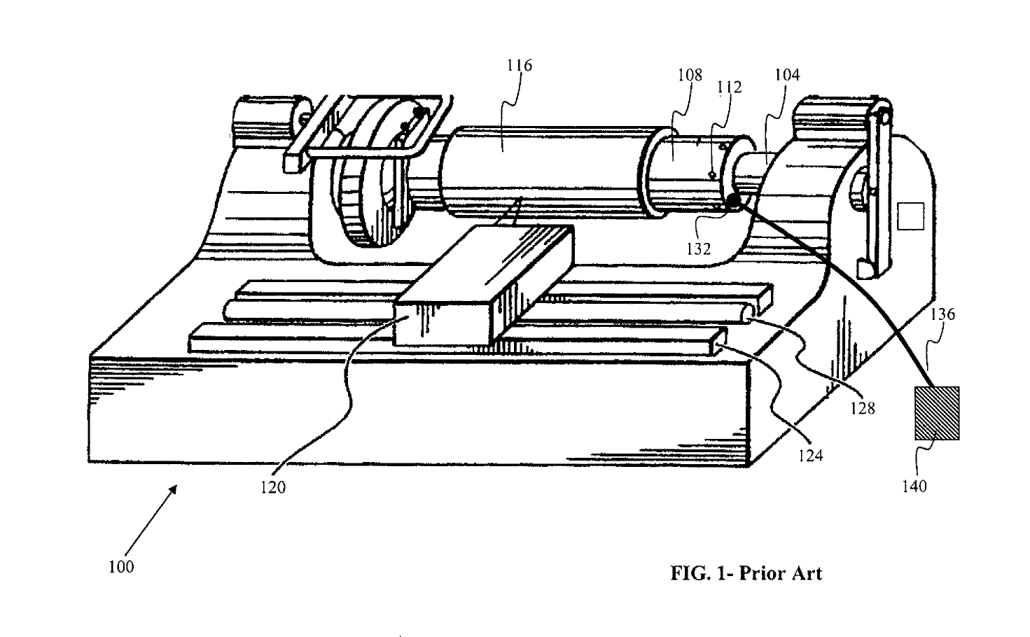

FIG. 2A is an illustration of a magnetic air connector as is described in the present invention;

FIG. 2B is a schematic view of the elements comprising the magnetic air connector;

FIG. 2C is a cross-section view of a magnetic air connector;

FIG. 2D is an illustration of a magnetic air connector attached to a mandrel adaptor;

FIG. 3A is a schematic view of the elements comprising the magnetic air connector including a valve;

FIG. 3B is a cross-section view of a magnetic air connector with a valve in a closed position (disconnected);

FIG. 3C is a cross-section view of a magnetic air connector with a valve in an open position (connected); and

FIG. 4 is a schematic of a laser processing system with a sleeve mounted on a mandrel adaptor using air supply, with an integrated magnetic air connector.

### DETAILED DESCRIPTION OF THE INVENTION

In the following detailed description, numerous specific details are set forth in order to provide a thorough understanding of the disclosure. However, it will be understood by those skilled in the art that the teachings of the present disclosure may be practiced without these specific details. In other instances, well-known methods, procedures, components and circuits have not been described in detail so as not to obscure the teachings of the present disclosure.

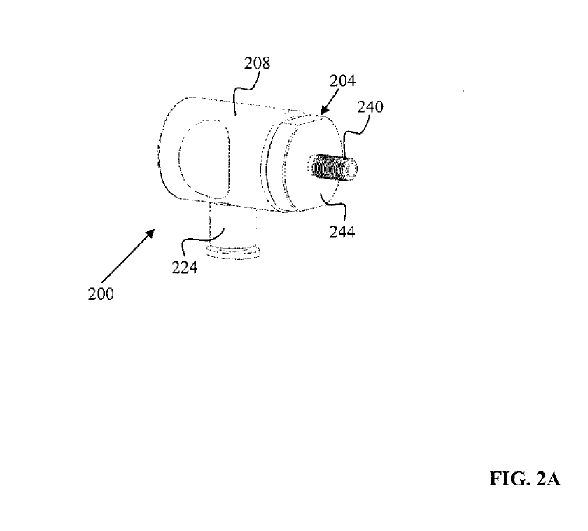

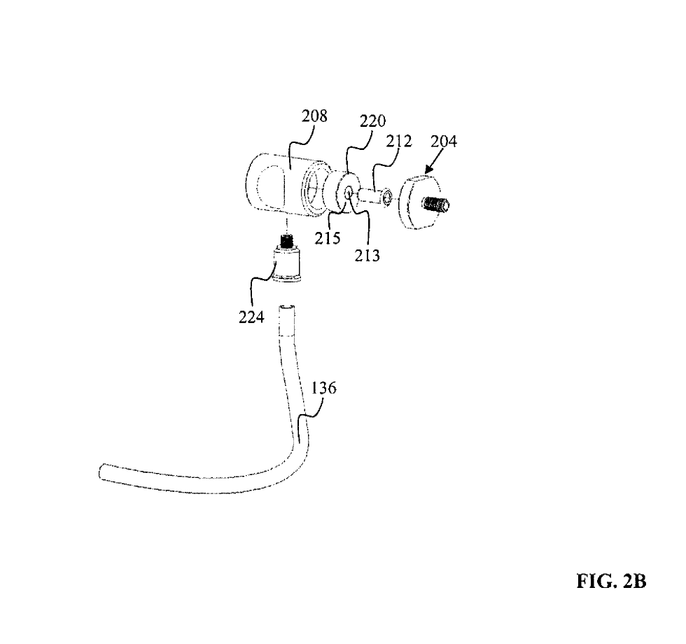

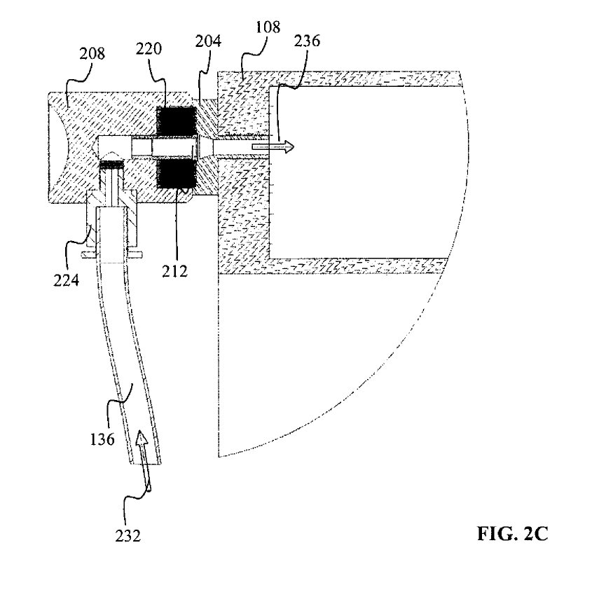

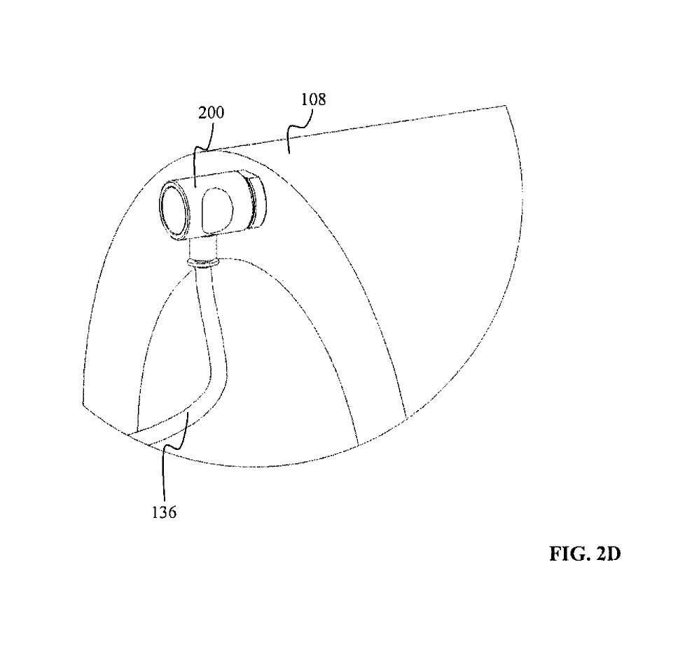

FIGS. 2A, 2B, 2C, and 2D show in detail the structure of a magnetic air connector 200. Magnetic air connector 200 is adapted to effectively facilitate air flow from air source 140 in direction 232 to air consumer such as mandrel adaptor 108, having the air enter into mandrel adaptor 108 in air flow direction 236.

Magnetic air connector 200 contain two main parts, main body 208 and an attach element 204. Attach element 204 is permanently attached to the air consumer such as mandrel adaptor 108. The attach element 204 is composed from two main elements, a hollow screw 240 adapted to fix attach element 204 to mandrel adaptor 108 and from a flat metal member 244. The metal member 244 is configured to attach to a magnetic element to firmly connect to main body 208, and to enable air flow thought a hole in the center of metal member 244 via hollow screw 240 into mandrel adaptor 108.

Air hose 136 can be attached to main body 208 via a hose adaptor 224. Magnet 220 is installed into magnetic air adaptor main body 208 and is secured to it. Magnet 220 is constructed with a hollow area 213 it its center, to enable the insertion of hollow pin 212. The diameter of hollow pin 212 in some embodiments may be substantially smaller than the diameter of magnet 220, thus creating a relatively small surface area for air injection supplied from air source 140 via air hose 136. The surface area 215 of magnet 220 therefore remains large, thus enabling a firm connection between the two parts (main body 208 and attach element 204) of the magnetic air connector 200.

In operation pressured air flows via air hose 136 through hollow pin 212 (inside main body 208), progressing through the hole in the center of metal member 244 and the hollow screw 240 which is connected to it, directly into an air consumer such as mandrel adaptor 108. The magnetic air connector 200 enables fast release or attach of air source 140 to or from mandrel adaptor 108, without the need to screw air source 140 to air consumer such as a mandrel 104 or mandrel adaptor 108. The release or attach is achieved by connecting or disconnecting magnet 220 (part of main body 208) to or from attach element 204.

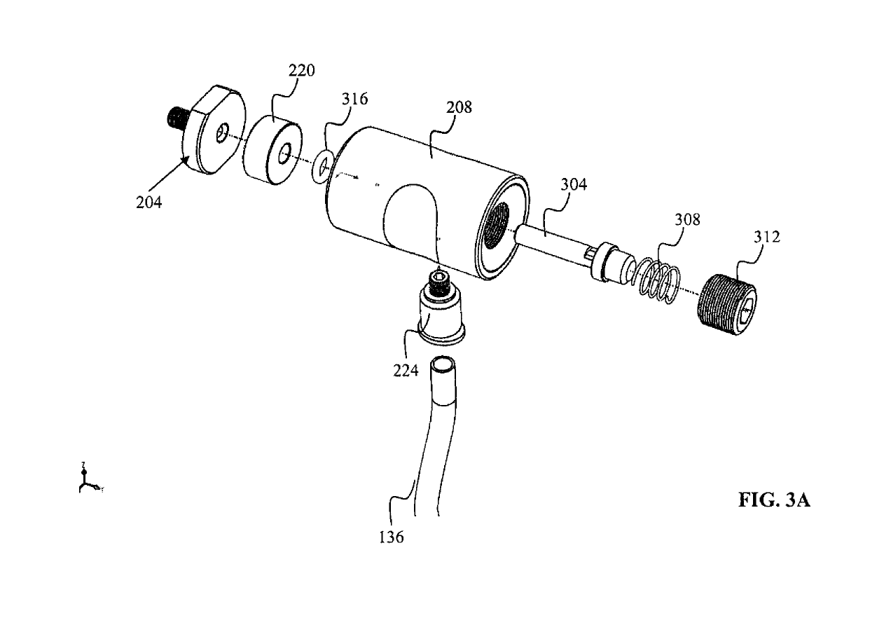

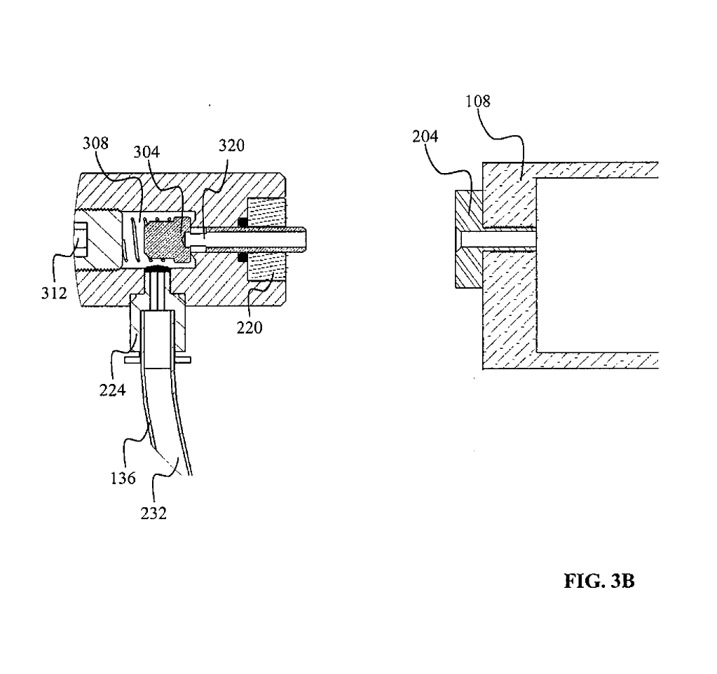

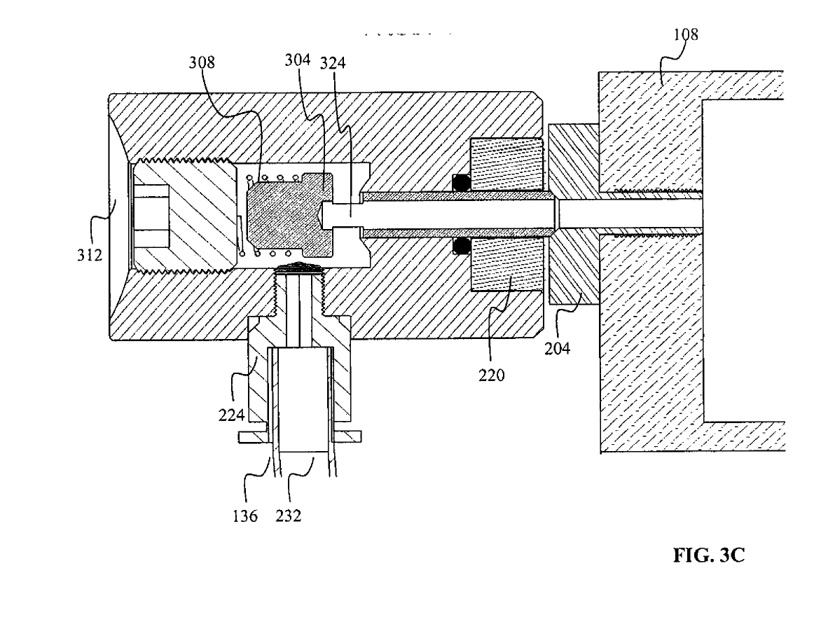

In another embodiment of the present invention shown in FIGS. 3A, 3B, and 3C an air valve 304 is integrated into the magnetic air connector 200. The air valve 304 is inserted into main body 208. Air valve 304 is secured on one side of main body 208 by a security screw 312, a spring 308 is placed between screw 312 and valve 304. On the other side valve 304 is inserted into magnet 220 and secured by ring 316. In operation, when connected to air source 140 attach element 204 presses valve 304 against spring 308, thus air valve 304 is opened 324, and enables air to flow from air source 140 to air consumer (shown in FIG. 3C). Disconnection of magnet 220 from attach element 204 will cause valve 304 to close 320 (pushed back by spring 308), thus shutting off air flow from air source 140.

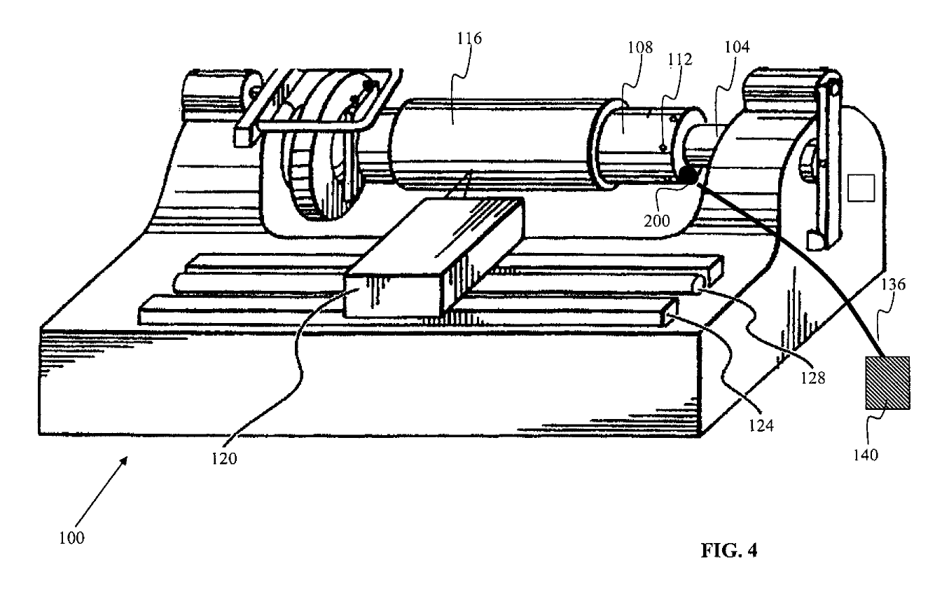

FIG. 4 shows a magnetic air adapter 200 integrated into imaging device 100. The magnetic air connector 200 is attached to mandrel adaptor 108 as is shown in FIG. 4, but it should be appreciated that in a different configuration the magnetic air connector 200 can be attached directly to mandrel 104.

The invention has been described in detail with particular reference to certain preferred embodiments thereof, but it will be understood that variations and modifications can be effected within the scope of the invention.

### PARTS LIST

100 imaging device
104 mandrel
108 mandrel adaptor
112 air holes
116 printing sleeve
120 imaging head
124 imaging head tracks
128 imaging head lead screw
132 air inlet into mandrel or mandrel adaptor
136 air hose
140 air source
200 magnetic air connector
204 attach element
208 main body
212 hollow pin
213 hollow area
215 surface of magnet
220 magnet
224 hose adaptor to main body
232 air flow from air source
236 air flow into mandrel adaptor
240 screw
244 metal member
304 valve
308 spring
312 security screw
316 ring
320 valve is closed position (no air flow)
324 valve in open position (air flows)

1. A magnetic air connector comprising:
an air inlet configured to connect to an air source;
a magnet configured with a hollow area to enable air flow through it;
a hollow pin inserted into said hollow area of said magnet; and
an attach element configured to attach to an air consumer on a first side and to said magnet on a second side.

2. The magnetic air connector according to claim 1 wherein a surface area of said magnet is substantially larger than said hollow area in said magnet.

3. The magnetic air connector according to claim 1 wherein said attach element comprising:
a metal member configured to attach to said magnet; and
a hollow screw configured to be attached to said air consumer.

4. The magnetic air connector according to claim 1 wherein said air consumer is a mandrel.

5. The magnetic air connector according to claim 1 wherein said air consumer is a mandrel adaptor.

6. The magnetic air connector according to claim 1 further comprising an air valve wherein said air valve is adapted to block air flow when in an open position and enable air flow when in closed position.
